(19) United States
(12) Patent Application Publication
(10) Pub. No.: US 2015/0316390 A1
(43) Pub. Date: Nov. 5, 2015

(54) DRIVING SUPPORT SYSTEM, AND CENTER AND ONBOARD APPARATUS CONFIGURING THE SYSTEM

(71) Applicant: DENSO CORPORATION, Kariya-city, Aichi-pref. (JP)

(72) Inventor: Shogo KAMEYAMA, Chiryu-city (JP)

(21) Appl. No.: 14/366,835

(22) PCT Filed: Nov. 20, 2012
(86) PCT No.: PCT/JP2012/007431

§ 371 Date: Jun. 19, 2014

(30) Foreign Application Priority Data
Dec. 21, 2011 (JP) 2011-280397

(51) Int. Cl. G01C 21/34; G08G 1/09

(52) U.S. Cl. CPC G01C 21/3484; G08G 1/091

(57) ABSTRACT

Provided is a driving support system provided with a center and a vehicle-mounted device which supports driving on the basis of operation support data transmitted from the center. The center receives, from the vehicle, operation data indicating driving operations, fuel consumption information, and travel path information relating to the travel path, aggregates the operation data on the basis of the travel path information, creates, on the basis of the fuel consumption information, operation support data for use in driving support from the aggregated operation data, and transmits the operation support data. When traveling a set route, the vehicle-mounted device applies to said route the operation support data on the basis of the travel path information, and supports driving such that the actual driving operations approach the driving operations indicated by said operation support data.

### CROSS REFERENCE TO RELATED APPLICATION

The present application is based on Japanese patent application No. 2011-280397 filed on Dec. 21, 2011, the content of which is incorporated herein by reference.

### TECHNICAL FIELD

The present disclosure relates to a driving support system including a center and an onboard apparatus that provides driving support based on operation support data transmitted from the center.

### BACKGROUND ART

Recently, a fuel efficiency of a vehicle (referred to hereinafter as fuel economy is important. The fuel economy is travel distance per unit fuel. Generally, the fuel economy is calculated as travel distance per liter. The fuel economy is part of costs to maintain a vehicle and is also an important factor from a viewpoint of environmental protection. An evaluation apparatus to appropriately evaluate the fuel economy has been proposed (e.g., see patent literature 1).

The fuel economy largely depends on travel routes for a vehicle. For example, the fuel economy degrades if an engine is loaded due to many upward slopes. There is proposed an automobile navigation system that configures support routes under the condition of good fuel economy (e.g., see patent literature 2).

However, the fuel economy varies with various factors in addition to travel routes. For example, it is known that the fuel economy largely varies with driving operation. That is, the fuel economy also largely varies with operation amounts of an accelerator pedal, a brake pedal, and a steering wheel.

It is known that the fuel economy also largely varies with vehicle states. That is, the fuel economy also largely varies with the vehicle's load weight and the use of an air conditioner.

For these reasons, it is insufficient to merely provide travel routes as described above. It may be possible to provide driving operation to some extent in order to improve the fuel economy. The result is to just provide better driving operation rather than the best one.

### PRIOR ART LITERATURES

### Patent Literatures

Patent Literature 1: JP-A-2001-349764

Patent Literature 2: JP-A-2009-019931 (corresponding to U.S. Patent Application Publication No. 20100179752)

### SUMMARY OF INVENTION

The present disclosure has been made in consideration of the foregoing. It is an object of the disclosure to provide a driving support system, a center configuring the system, and an onboard apparatus capable of ensuring driving support according to a best possible driving operation and improving fuel economy.

According to one example of the present disclosure, a driving support system comprises: a center (30) that transmits operation support data based on travel-related data transmitted from a vehicle; and an onboard apparatus (10) that provides driving support based on the operation support data transmitted from the center (30). The center (30) receives operation data indicative of driving operation, fuel economy information, and travel path information about a travel path, as the travel-related data, compiles the operation data based on the travel path information, and from among the compiled operation data, transmits the operation support data for use in the driving support based on the fuel economy. The onboard apparatus (10) applies the operation support data to a predetermined route to be traveled based on the travel path information and provides the driving support so that actual driving operation approximates to the driving operation indicated by the operation support data.

The driving support system, the center, and the onboard apparatus described above enable to provide the driving support according to the best possible driving operation and improve the fuel economy.

### BRIEF DESCRIPTION OF DRAWING

The above and other objects, features, and advantages of the disclosure will be more apparent from the following detailed description with reference to the accompanying drawings in which:

FIG. 1 is a block diagram illustrating a schematic configuration of a driving support system;

FIG. 2 is an explanatory diagram schematically illustrating a vehicle drivetrain;

FIG. 3 is a flowchart illustrating a data transmission process;

FIG. 4 is a flowchart illustrating a data processing process;

FIG. 5 is a flowchart illustrating an operation data compile process of the data compile process; and

FIG. 6 is a flowchart illustrating a driving operation support process.

### MODES FOR CARRYING OUT INVENTION

An embodiment will be described with reference to the accompanying drawings.

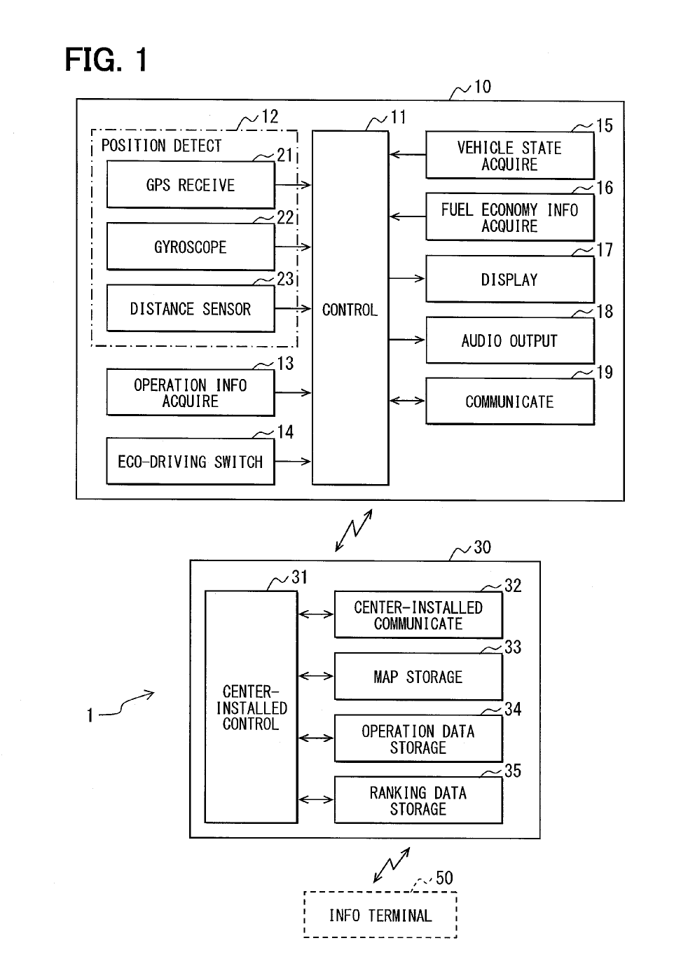

FIG. 1 is a block diagram illustrating a schematic configuration of a driving support system 1. The driving support system 1 includes an onboard apparatus 10 and a center 30.

The onboard apparatus 10 is mainly configured as a control portion 11. The control portion 11 is mainly configured as a microcomputer including a CPU, ROM, RAM, I/O devices, and a bus line connecting these components.

The control portion 11 connects with a position detection portion 12, an operation information acquisition portion 13, an eco-driving switch 14, a vehicle state acquisition portion 15, a fuel economy information acquisition portion 16, a display portion 17, an audio output portion 18, and a communication portion 19.

The position detection portion 12 receives a signal transmitted from an artificial satellite for GPS (Global Positioning System). The position detection portion 12 includes a GPS receiver 21, a gyroscope 22, and a distance sensor 23. The GPS receiver 21 detects vehicle's position coordinates and altitudes. The gyroscope 22 outputs a detection signal corresponding to an angular velocity of rotational movement applied to the vehicle. The distance sensor 23 outputs the vehicle' travel distance. The control portion 11 calculates the vehicle's current position, orientation, and speed based on signals output from the sensors 21 through 23.

The operation information acquisition portion 13 acquires operation information via an in-vehicle network such as CAN. The operation information includes operation amounts corresponding to an accelerator pedal, a brake pedal, and a steering wheel.

The eco-driving switch 14 enables eco-driving mode. The eco-driving mode will be described later. Selecting the eco-driving mode automatically improves the fuel economy.

The vehicle state acquisition portion 15 acquires a vehicle state. The vehicle state includes the selection or not-selection of the eco-driving mode, the use or not-use of the air conditioner, a load weight, and an ambient camera image. To approximate the load weight, the number of occupants may be acquired from a sensor provided for a seat and average weight values may be used. The ambient camera image may be available as a camera image corresponding to the rear of the vehicle, for example.

The fuel economy information acquisition portion 16 is used to acquire the vehicle's fuel economy. The fuel economy is assumed to be instantaneous fuel economy. Obviously the configuration may acquire average fuel economy during a predetermined period in the past.

The display portion 17 is available as a color display apparatus having a display screen such as a liquid crystal display. The display portion 17 is capable of displaying various images according to video signals supplied from the control portion 11. According to the embodiment, the display portion 17 mainly displays the guidance about driving operation.

The audio output portion 18 is configured to audibly notify a user of various types of information. Similarly to the display portion 17, the audio output portion 18 mainly notifies the user of the guidance about driving operation.

The communication portion 19 is configured to enable data communication with the center 30. Specifically, the onboard apparatus 10 is wirelessly connected to the network via the communication portion 19 for data communication with the center 30.

The center 30 is mainly configured as a center-installed control portion 31. Similarly to the control portion 11, the center-installed control portion 31 is mainly configured as a known microcomputer including a CPU, ROM, RAM, I/O devices, and a bus line connecting these components. The center-installed control portion 31 connects with a center-installed communication portion 32, a map storage portion 33, an operation data storage portion 34, and a ranking data storage portion 35.

The center-installed communication portion 32 is configured to enable data communication with the onboard apparatus 10. Specifically, the center is wirelessly connected to the network via the center-installed communication portion 32 for data communication with the onboard apparatus 10.

The map storage portion 33 is configured to store map data and supply the map data to the center-installed control portion 31. The map data stored in the map storage portion 33 includes road data and facility data. The road data indicates road situations using nodes corresponding to predetermined spots such as intersections and links to connect nodes with each other. The facility data is associated with facilities on the map. Supplied with the map data, the center-installed control portion 31 is capable of route retrieval. The center-installed control portion 31 enables to select operation data most suitable for the retrieved route.

The operation data storage portion 34 is configured to store operation data transmitted from the onboard apparatus 10. As will be described later, the operation data is linked to various types of information and is stored in the operation data storage portion 34.

The ranking data storage portion 35 is configured to store ranking data that is associated with the fuel economy and is supplied to users.

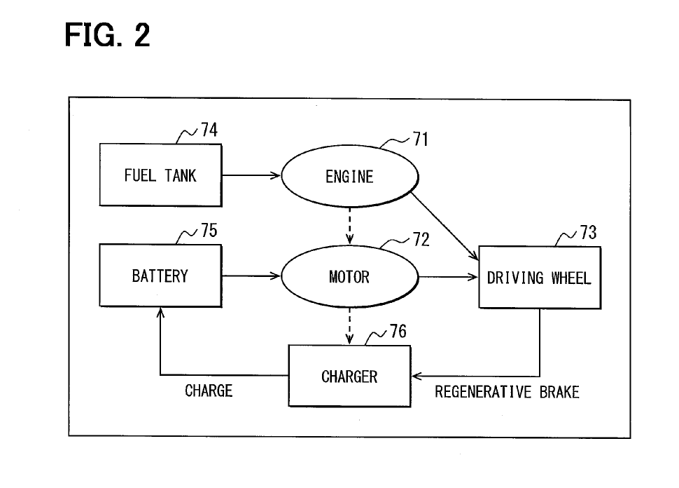

The following describes a vehicle where the onboard apparatus 10 is mounted. FIG. 2 is an explanatory diagram schematically illustrating a vehicle drivetrain.

This vehicle represents a hybrid vehicle, which uses two types of driving sources, that is, an engine 71 and a motor 72, to drive a driving wheel 73 for running. The hybrid vehicle starts the engine 71 and uses it along with the motor 72 according to conditions such as an increase in the operation amount of an accelerator pedal. The engine 71 operates on fuel from a fuel tank 74. The motor 72 operates on electric power from a battery 75. The battery 75 connects with a charger 76. When the vehicle is braked, a regenerative brake converts rotation energy of the driving wheel 73 into electric energy and charges the battery 75 using the charger 76.

Suppressing a load on the engine 71 is effective from the viewpoint of improving the fuel economy. Specifically, it may be effective to avoid sudden acceleration or excess power consumption. The use of an air conditioner, an audio device, or a heat seater consumes the power.

The above-mentioned eco-driving mode automatically suppresses sudden acceleration. The eco-driving mode controls the drive so as to suppress sudden acceleration even if the operation amount of the accelerator pedal increases. According to the embodiment, pressing the eco-driving switch 14 illustrated in FIG. 1 enables the eco-driving mode.

The regenerative brake charges the battery 75 to increase situations of using the motor 72, thereby improving the fuel economy. However, increasing the operation amount of the brake pedal decreases the recovery efficiency of energy and increases variations in the heat. Avoiding sudden acceleration is important.

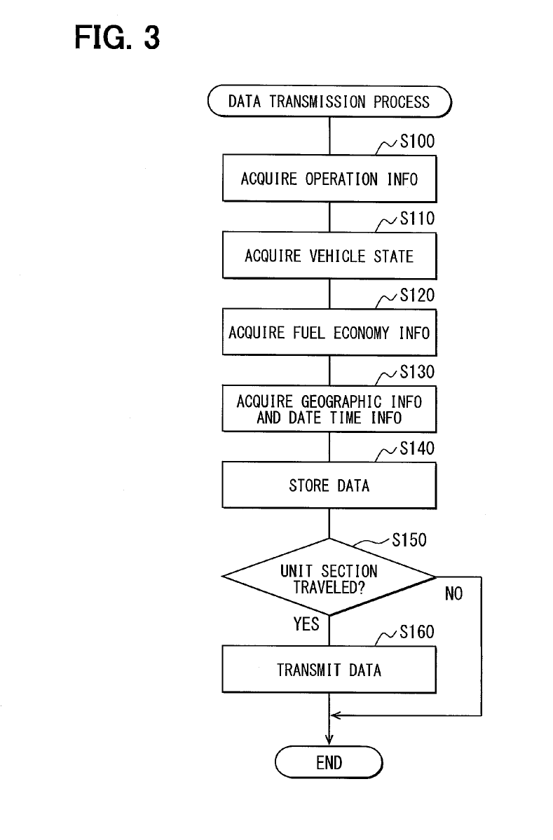

The following describes a data transmission process performed by the control portion 11 of the onboard apparatus 10. FIG. 3 is a flowchart illustrating the data transmission process. The data transmission process is repeatedly performed while the vehicle is running.

At S100, the control portion 11 acquires operation information. This process acquires operation information from the operation information acquisition portion 13 illustrated in FIG. 1. As described above, the operation information includes operation amounts corresponding to the accelerator pedal, the brake pedal, and the steering wheel.

At S110, the control portion 11 acquires a vehicle state. The process acquires a vehicle state from the vehicle state acquisition portion 15 illustrated in FIG. 1. As described above, the vehicle state includes the selection or not-selection of the eco-driving mode, the use or not-use of the air conditioner, a load weight, and an ambient camera image.

At S120, the control portion 11 acquires fuel economy information. The process acquires vehicle's fuel economy from the fuel economy information acquisition portion 16 illustrated in FIG. 1. The description assumes that the instantaneous fuel economy is acquired.

At S130, the control portion 11 acquires geographic and date-time information. The process acquires the vehicle's current position or altitude and date-time information (day, time, and day of the week) acquired as GPS data detected in the position detection portion 12 illustrated in FIG. 1.

The process at S110 through S130 acquires the vehicle state, the fuel economy information, and the geographic and date-time information corresponding to the operation information acquired at S100. At S140, the control portion 11 stores these data as a set.

At S150, the control portion 11 determines whether the vehicle travels a unit section. The unit section may be predetermined on the map. For example, the unit section may be defined as section AB from intersection A to the next intersection B. If it is determined that the vehicle travels the unit section (YES at S150), the control portion 11 proceeds to S160, transmits data stored at S140, and then terminates the data transmission process. If it is determined that the vehicle does not travel the unit section (NO at S150), the control portion 11 skips the process at S160 and terminates the data transmission process.

While the vehicle travels the unit section, the data transmission process successively samples the operation information and vehicle states, fuel economy information, and geographic and date-time information corresponding to the operation information and transmits the information to the center 30.

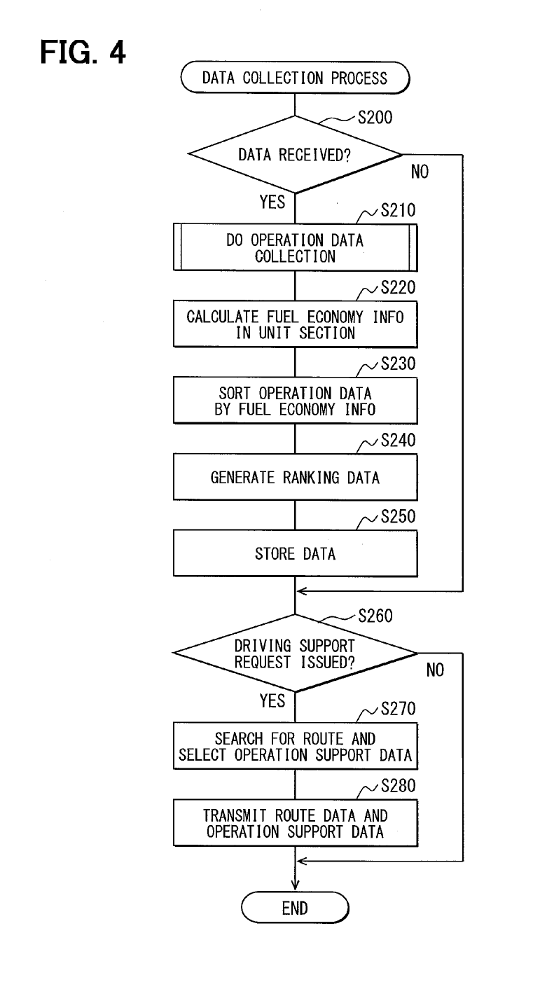

The following describes a data compile process performed by the center-installed control portion 31 of the center 30. FIG. 4 is a flowchart illustrating the data compile process. The data compile process is performed at a predetermined time interval.

At S200, the center-installed control portion 31 determines whether there is receipt of the data from the onboard apparatus 10. This process corresponds to S160 in FIG. 3. The center-installed control portion 31 proceeds to S210 if it is determined that data is received (YES at S200). The center-installed control portion 31 proceeds to S260 if it is determined that data is not received (NO at S200).

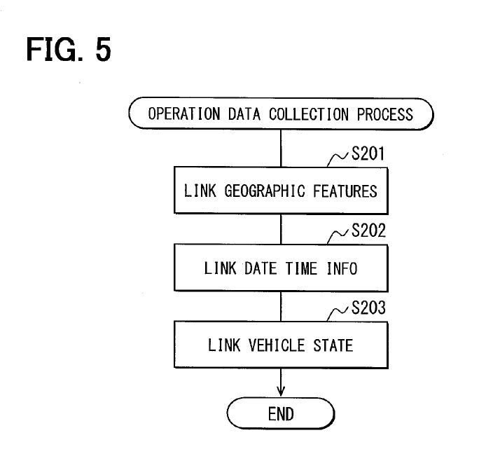

At S210, the center-installed control portion 31 performs an operation data compile process. This process links various types of information to the operation data from the onboard apparatus 10. A flowchart in FIG. 5 illustrates the process in detail.

At S201 in FIG. 5, the center-installed control portion 31 links geographic features to the operation data, which are transmitted on a unit section basis. The geographic feature includes information based on geographic information and is transmitted along with the operation data. The geographic feature represents road curves in the unit section, or information representing upward or downward inclination of roads.

At S202 in FIG. 5, the center-installed control portion 31 links date-time information to the operation data, which are transmitted on a unit section basis. The acquired date-time information to be linked includes the day, the time, and the day of the week as described above.

At S203, the center-installed control portion 31 links a vehicle state to the operation data, which are transmitted on a unit section basis. The vehicle state includes the selection or not-selection of the eco-driving mode, the use or not-use of the air conditioner, a load weight, and an ambient camera image.

At S220 in the description of FIG. 4, the center-installed control portion 31 calculates fuel economy information in the unit section. As described above, the onboard apparatus 10 acquires the instantaneous fuel economy (S120 in FIG. 3). In this example, the center-installed control portion 31 calculates average fuel economy to travel the unit section.

The process at S210 and S220 associates the operation data for each unit section with the geographic feature, the date-time information, the vehicle state, and the average fuel economy per unit section.

At S230, the center-installed control portion 31 sorts the operation data by the average fuel economy. The operation data is sorted in descending order of the fuel economy. Highly ranked operation data results from ranking according to the fuel economy for actual vehicle running. The highly ranked operation data exhibits the best possible driving operation although related to other factors such as vehicle states. Extraordinary operation data (superhuman data) may be acquired by collecting data on a worldwide basis.

At S240, the center-installed control portion 31 generates ranking data. The ranking data may be generated on an individual-by-individual basis, a district-by-district basis, or a country-by-country basis. The ranking data does not directly concern the driving support. However, providing the ranking data may promote awareness of improving the fuel economy.

At S250, the center-installed control portion 31 stores the generated data. The operation data is stored in the operation data storage portion 34 illustrated in FIG. 1. The ranking data is stored in the ranking data storage portion 35 illustrated in FIG. 1.

As will be described later, the onboard apparatus 10 requests the driving support of the center 30 when needed. Specifically, the onboard apparatus 10 transmits a current location and a destination and requests a route to the destination and operation support data for the route to travel.

At S260, the center-installed control portion 31 determines whether there is the driving support request. If it is determined that there is the driving support request (YES at S260), the center-installed control portion 31 proceeds to S270. If it is determined that there is no driving support request (NO at S260), the center-installed control portion 31 skips the subsequent process and terminates the data compile process.

At S270, the center-installed control portion 31 retrieves a route based on the transmitted current location and destination and selects operation data suitable for the retrieved route as operation support data.

The following describes selection of operation support data.

As described above, the onboard apparatus 10 transmits a vehicle state or the date-time information for each unit section (YES at S150 and S160 in FIG. 3). Taking into account these pieces of information, operation data containing the best possible fuel economy is selected as operation support data. For example, the center-installed control portion 31 weights elements configuring the vehicle state and the date-time information and selects operation data containing the similar vehicle state and date-time information.

Operation data to be selected is not limited to operation data for the same unit section as the one configuring a travel route. Operation data may be selected from operation data for other unit sections exhibiting similar geographic features linked to the operation data, depending on whether the fuel economy is efficient.

At S280, the center-installed control portion 31 transmits the retrieved route and the selected operation support data and then terminates the data compile process.

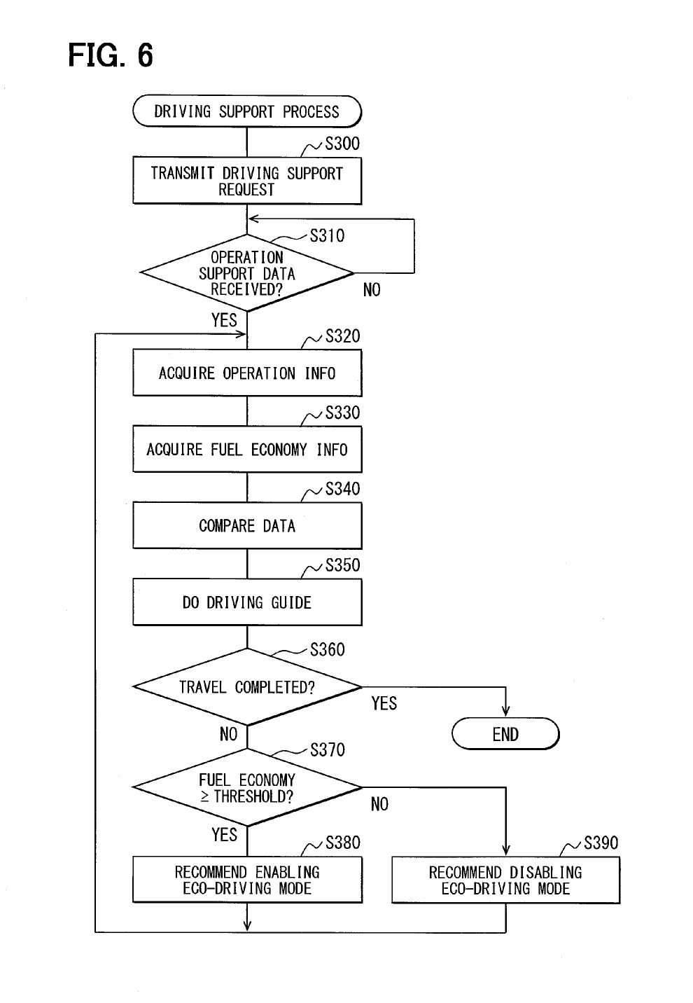

The following describes a driving operation support process performed by the control portion 11 of the onboard apparatus 10. FIG. 6 is a flowchart illustrating the driving operation support process. The driving operation support process is performed in the event of route retrieval, for example.

At S300, the control portion 11 transmits a driving support request. This process transmits the vehicle's current location and destination to the center 30. In response, the center 30 retrieves a route according to the current location and the destination, selects the operation support data (S270 in FIG. 4), and transmits the retrieved route and the operation support data (S280).

At S310, the control portion 11 determines whether there is receipt of the operation support data from the center 30. The control portion 11 proceeds to S320 if it is determined that the operation support data is received (YES at S310). The control portion 11 repeats the determination at S310 if it is determined that no operation support data is received (NO at S310).

At S320, the control portion 11 acquires operation information. This process acquires operation information about the vehicle from the operation information acquisition portion 13 when the vehicle travels the route transmitted from the center. As described above, the operation information includes operation amounts corresponding to the accelerator pedal, the brake pedal, and the steering wheel.

At S330, the control portion 11 acquires fuel economy information. This process acquires the fuel economy information about the vehicle from the fuel economy information acquisition portion 16 when the vehicle travels the route transmitted from the center 30. The fuel economy is assumed to be instantaneous fuel economy.

At S340, the control portion 11 performs data comparison. This process compares the driving operation indicated by the operation support data with the actual driving operation indicated by the operation information acquired at S320.

At S350, the control portion 11 performs driving guidance so as to approximate the actual driving operation to the driving operation indicated by the operation support data. For example, the operation amount of the accelerator pedal may be larger than the operation amount of the operation support data. In such a case, the control portion 11 allows the audio output portion 18 to provide an instruction to more gently operate the accelerator pedal. For example, the control portion 11 monitors the operation amount of the accelerator pedal and allows the display portion 17 to display whether the operation amount is appropriate.

The embodiment may allow a display monitor to display a camera image linked to the operation support data. For example, the display portion 17 is used to display a camera image toward the rear of the vehicle.

At S360, the control portion 11 determines whether the travel along the route is complete. If it is determined that the travel along the route is complete (YES at S360), the control portion 11 skips the subsequent process and terminates the driving operation support process. If it is determined that the travel along the route is incomplete (NO at S360), the control portion 11 proceeds to S370.

At S370, the control portion 11 determines whether the fuel economy is greater than or equal to a threshold value. The fuel economy is not good if it is determined that the fuel economy is greater than or equal to the threshold value (YES at S370). In this case, the control portion 11 provides guidance to enable the eco-driving mode at S380 and then repeats the process at S320 and later. The guidance on the eco-driving mode signifies a prompt to press the eco-driving switch 14 on the premise that the eco-driving mode is not used. On the other hand, the fuel economy is good if it is determined that the fuel economy is smaller than the threshold value (NO at S370). In this case, the control portion 11 provides guidance to disable the eco-driving mode at S390 and then repeats the process at S320 and later.

The following describes technical effects of the driving support system 1 according to the embodiment.

According to the embodiment, the center 30 receives the operation data indicating driving operation, the fuel economy information, and the geographic information (YES at S200 in FIG. 4). The center links geographic features to the operation data (S201 in FIG. 5) and compiles the operation data on a unit-section-by-unit section basis (S210 in FIG. 4). The center 30 calculates the average fuel economy information (S220), sorts the operation data by the fuel economy information (S230), and transmits the operation support data (S280). The onboard apparatus 10 receives the operation support data (YES at S310 in FIG. 6) and then acquires the operation information indicating the actual driving operation (S320). The onboard apparatus 10 compares the actual driving operation with driving operation indicated by the operation support data (S340) and provides the driving guidance so that the actual driving operation approximates to the driving operation indicated by the operation support data (S350).

That is, the center compiles actual operation data transmitted from the vehicle using geographic information and generates operation support data based on the fuel economy information. Extraordinary operation data (superhuman data) may be acquired by collecting the operation support data on a worldwide basis. It is possible to acquire the best possible driving operation from the viewpoint of fuel economy improvement. This enables to provide the driving support according to the best possible driving operation and improve the fuel economy.

According to the embodiment, the control portion 11 performs the driving guidance (S350 in FIG. 6). At the same time, when the fuel economy is greater than or equal to the threshold value (YES at S370), that is, the fuel economy is not good, the control portion 11 provides guidance to enable the eco-driving mode, which avoids sudden acceleration even in a situation where the operation amount of the accelerator pedal increase. This enables to improve the fuel economy regardless of the user's driving technique.

According to the embodiment, the onboard apparatus 10 performs the driving operation support process (see FIG. 6) and functions as a data acquisition device that performs the data transmission process (see FIG. 3). All vehicles mounted with the onboard apparatus 10 can also function as probe cars to facilitate acquisition of operation data.

According to the embodiment, the onboard apparatus 10 acquires a vehicle state and transmits it to the center 30 (S110 and S160 in FIG. 3). The center 30 links the vehicle state to the operation data (S203 in FIG. 5). The onboard apparatus 10 mounted to a certain vehicle is thereby capable of the driving support based on the operation support data approximate to the vehicle state of the certain vehicle itself. When receiving the driving support request from the onboard apparatus 10 (YES at S260 in FIG. 4), the center 30 selects operation support data according to the vehicle state of the onboard apparatus 10 and transmits the operation support data (S270 and S280). The center 30 thereby transmits the operation support data approximate to the vehicle state to facilitate processing on the onboard apparatus 10.

According to the embodiment, the onboard apparatus 10 acquires date-time information and transmits it to the center (S130 and S160 in FIG. 3). The center 30 links the date-time information to the operation data (S202 in FIG. 5). The onboard apparatus 10 is thereby capable of the driving support based on the operation support data containing the matching number of hours per day or the matching day of the week. When detecting a driving support request from the onboard apparatus 10 (YES at S260 in FIG. 4), the center 30 selects operation support data corresponding to the travel date-time and transmits the operation support data (S270 and S280). The center 30 thereby transmits the operation support data corresponding to the vehicle's travel date-time to facilitate processing of the onboard apparatus 10.

According to the embodiment, the center 30 compiles operation data for each unit section (S210 in FIG. 4). The center 30 sorts operation data according to the average fuel economy for each unit section (S220 and S230). The onboard apparatus 10 can thereby apply the operation support data to each unit section to facilitate handling of operation support data.

According to the embodiment, operation data to be selected is not limited to the same unit section as the one configuring a travel route. Operation data may be selected from another unit section exhibiting similar geographic features linked to the operation data depending on whether the fuel economy is efficient (S270 in FIG. 4). This enables to use operation support data corresponding to the efficient fuel economy.

In the embodiment, a camera image linked to the operation support data can be displayed on a screen of the display portion 17. For example, the display portion 17 may be used to display a camera image of the rear side of the vehicle. The driver can recognize others' driving states as realtime images. When the operation support data are operation support data about other similar unit sections, scenes of foreign countries are displayed. The driver can enjoy feelings of driving across foreign countries while staying in Japan.

The driving support system 1 in the embodiment can correspond to “driving support system” in the appended claims. Similarly, the onboard apparatus 10 can correspond to “onboard apparatus” and “data acquisition device.” The center 30 can correspond to “center.”

The operation information, the vehicle state, the fuel economy information, and the geographic and date-time information as data to be transmitted to the center 30 from the onboard apparatus 10 can correspond to “travel-related data.” The geographic information can correspond to “travel path information.”

Embodiments are not limited to the above-mentioned embodiment. Modifications are described below.

According to the embodiment, the display portion 17 uses its display screen to display the guidance or a camera image for driving support (S350 in FIG. 6). However, the display portion 17 may display ranking data generated at S240 in FIG. 4. As described above, the ranking data may be available as ranking data for fuel economy in an individual-by-individual basis competition, a district-by-district basis competition, a country-by-country basis competition, or the like. Displaying the ranking data may promote the motive to improve the fuel economy and may consequently improve the fuel economy. The ranking data may be displayed on an information terminal 50 such as a PC or a mobile telephone as well as the onboard apparatus 10.

The embodiment provides guidance to enable the eco-driving mode (S380) if the fuel economy is greater than or equal to the threshold value (S370 in FIG. 6). Alternatively, guidance may be provided to enable the eco-driving mode if there is a large difference between the driving operation indicated by the operation support data and the actual driving operation.

The embodiment transmits operation data to the center 30 for each unit section (YES at S150 and S160 in FIG. 3). The center 30 processes the operation data for each unit section (S210 through S240 in FIG. 4). Alternatively, it may be preferable to transmit acquired operation data to the center 30 in real time without awaiting travel along the unit section. The center 30 may generate operation data for each unit section from the operation data transmitted in real time. The operation data transmitted in real time may be used as is and processed as operation data for each spot on the map.

The present disclosure can provide various modes of the driving support system.

According to one mode, for example, the driving support system includes a center and an onboard apparatus. The center transmits operation support data based on travel-related data transmitted from a vehicle to the onboard apparatus. The onboard apparatus is mounted on the vehicle and provides driving support based on the operation support data transmitted from the center.

In particular, the center receives travel-related data such as operation data indicating the driving operation, fuel economy information, and travel path information about a travel route. The operation data includes at least the operation amount of an accelerator pedal. The operation data may further include the operation amount of a steering wheel. Moreover, the operation data may include the operation amount of a brake pedal for a hybrid vehicle that uses a regenerative brake. The fuel economy information may be available as instantaneous fuel economy at a given time or average fuel economy during a predetermined section. The travel path information may represent a vehicle position at a given time or a predetermined section. Further, the travel path information may include road curves or slopes.

The center compiles operation data based on the travel path information. This is because the operation data depends on a travel path. Based on the fuel economy information, the center transmits the operation support data from among the compiled operation data, so that the operation support data is used for driving support. For example, the complied operation data contains operation data that exhibits relatively efficient fuel economy. Such operation data is transmitted as the operation support data.

When the vehicle travels a predetermined route, the onboard apparatus applies the operation support data to the route based on the travel path information and provides driving support so that the actual driving operation approximates to the driving operation indicated by the operation support data.

The above-mentioned driving support system compiles actual operation data transmitted from the vehicle using the travel path information and generates operation support data based on the fuel economy. Extraordinary operation data may be highly possibly found from operation data that is collected on a worldwide basis. It is possible to acquire the best possible driving operation from the viewpoint of fuel economy improvement. This enables to provide the driving support according to the best possible driving operation and improve the fuel economy.

Some hybrid vehicles are provided with the eco-driving mode. However, users may not recognize such special mode. Assume that the onboard apparatus is mounted on a vehicle capable of control in the eco-driving mode that suppresses an engine load regardless of driving operation. Under this assumption, the onboard apparatus may recommend enabling the eco-driving mode to provide the driving support based on the driving operation indicated by the operation support data and the actual driving operation.

A large difference may be observed between “the driving operation indicated by the operation support data and the actual driving operation” as described above. A large difference may be observed in the fuel economy based on both driving operations. For example, there may be a possibility of prompting a user to enable the eco-driving mode if the driving support does not improve his or her driving operation and makes the fuel economy inefficient. This enables to improve the fuel economy regardless of user's driving technique.

There may be a configuration in which a so-called probe car transmits travel-related data to the center. The same vehicle may function as a probe car and a driving support vehicle. That is, the onboard apparatus may provide the driving support and concurrently function as a data acquisition device that transmits travel-related data to the center. All vehicles mounted with the onboard apparatus can also function as probe cars to facilitate acquisition of operation data.

The fuel economy largely depends on vehicle states. Further, the center may be configured to receive a vehicle state as travel-related data and compiles operation data in association with the vehicle state.

The vehicle state includes the use or not-use of the air conditioner and a load weight (the number of passengers), for example. The onboard apparatus can associate the vehicle state with the operation data and thereby use the operation support data approximate to the vehicle state.

There may be a case where the onboard apparatus functions as a data acquisition device and already reveals a state of the vehicle that needs driving support. In such a case, the center may transmit operation support data based on the vehicle state in addition to the fuel economy information. The center thereby transmits the operation support data approximate to the vehicle state to advantageously facilitate processing on the onboard apparatus.

Even if the vehicle travels the same route, the fuel economy largely depends on the number of hours per day or the day of the week that may easily cause traffic congestion. In view of this, the center may receive date-time information as the travel-related data and compiles operation data in association with the date-time information.

The date-time information includes the day, the time, and the day of the week, for example. The onboard apparatus can associate the date-time information with operation data and thereby use the operation support data containing the number of hours per day or the day of the week that matches.

There may be a case where the onboard apparatus functions as a data acquisition device and already reveals a vehicle's travel date-time that needs driving support. In such a case, the center may transmit operation support data based on the date-time information in addition to the fuel economy information. The center thereby transmits the operation support data for the vehicle's travel date-time to advantageously facilitate processing on the onboard apparatus.

Compiling operation data based on the travel path information may use operation data corresponding to the vehicle position at a given time, for example. The operation data corresponds to spots on the map. In this case, however, the total number of operation data increases extremely.

In view of this, the center may compile operation data for each unit section based on the travel path information. In this case, the center may treat operation data transmitted on a spot basis as operation data corresponding to each unit section. Alternatively, operation data may be transmitted to the center on a unit section basis. The onboard apparatus can thereby apply the operation support data to each unit section to facilitate handling of operation support data. The center may transmit operation support data based on the average fuel economy for each unit section.

The onboard apparatus may apply operation support data to each unit section configuring the route and thereby use operation support data for the same unit section as that configuring the route. In this case, sufficient driving support may be expected from the operation support data acquired from the vehicle's actual travel along the same route. It may be favorable to use operation support data for a unit section similar to the one configuring the route. This is because matching geographic features may increase the possibility of using operation support data associated with more efficient fuel economy.

The embodiments, the configurations, and the modes of the driving support system according to the present disclosure, and the center and the onboard apparatus configuring the driving support system, as have been described, are not limited to the above-mentioned ones. For example, the scope of the embodiments, the configurations, and the modes of the driving support system according to the disclosure also covers embodiments, configurations, and modes resulting from appropriately combining the disclosed technical aspects with different embodiments, configurations, and modes.

1. A driving support system comprising:
a center that transmits operation support data based on travel-related data transmitted from a vehicle; and
an onboard apparatus that provides driving support based on the operation support data transmitted from the center,
wherein:
the center is configured to
receive operation data indicative of driving operation, fuel economy information, and travel path information about a travel path, as the travel-related data,
compile the operation data based on the travel path information, and
from among the compiled operation data, transmit the operation support data for use in the driving support based on the fuel economy; and
the onboard apparatus is configured to
apply the operation support data to a predetermined route to be traveled based on the travel path information and
provide the driving support so that actual driving operation approximates to the driving operation indicated by the operation support data.

2. The driving support system according to claim 1, wherein
on an assumption that the onboard apparatus is mounted on a vehicle controllable in an eco-driving mode for suppressing an engine load regardless of the driving operation, the onboard apparatus is configured to provide the driving support by recommending the eco-driving mode based on a driving operation indicated by the operation support data and an actual driving operation.

3. The driving support system according to claim 1,
wherein the onboard apparatus provides the driving support and functions as a data collection device transmitting the travel-related data to the center.

4. The driving support system according to claim 1,
wherein the center further receives a vehicle state indicative of a state of the vehicle as the travel-related data and compiles the operation data by associating the vehicle state with the operation data.

5. The driving support system according to claim 4,
wherein the center transmits the operation support data based on the vehicle state in addition to the fuel economy information.

6. The driving support system according to claim 1,
wherein the center receives date-time information as the travel-related data and compiles the operation data by associating the date-time information with the operation data.

7. The driving support system according to claim 6,
wherein the center transmits the operation support data based on the date-time information in addition to the fuel economy information.

8. The driving support system according to claim 1,
wherein the center compiles the operation data on a unit section basis based on the travel path information.

9. The driving support system according to claim 8,
wherein the center transmits the operation support data based on average fuel economy for each unit section.

10. The driving support system according to claim 8,
wherein the onboard apparatus is capable of applying the operation support data to the route when the operation support data corresponds to a unit section same as a unit section configuring the route.

11. The driving support system according to claim 1,
wherein the onboard apparatus is capable of applying the operation support data to the route when the operation support data corresponds to a unit section similar to a unit section configuring the route.

12. A center configuring the driving support system according to claim 1.

13. An onboard apparatus configuring the driving support system according to claim 1.

14. The driving support system according to claim 1, wherein:
the center is configured to
receive the operation data indicative of driving operation, fuel economy information, and travel path information about a travel path from a plurality of vehicles and
compile and store the operation data in association with the fuel economy information and the travel path information in an operation data storage portion; and
when the onboard apparatus issues a request to transmit the operation support data used for the driving support corresponding to the predetermined route, the center selects the operation data to be transmitted as the operation support data from among the operation data stored in the operation data storage portion based on the fuel economy information and travel path information associated with the operation data and transmits the selected operation data to the onboard apparatus.

15. The driving support system according to claim 1,
wherein the operation data includes at least a operation amount of an accelerator pedal of the vehicle.

16. The driving support system according to claim 15,
wherein the operation data further includes at least one of an operation amount of a steering wheel or an operation amount of a brake pedal

17. The driving support system according to claim 1,
wherein the center sorts the compiled operation data by the fuel economy to generate ranking data.

18. The driving support system according to claim 14,
wherein the center sorts the compiled operation data by the fuel economy to generate ranking data.
wherein the onboard apparatus displays the ranking data for the fuel economy in an individual-by-individual basis competition or in a district-by-district basis competition or in a country-by-country basis competition.
